(19) United States
(12) Patent Application Publication
(10) Pub. No.: US 2005/0126855 A1
(43) Pub. Date: Jun. 16, 2005

(54) Ladder and safety device therefor

(76) Inventor: Jack Tilley, Ball Ground, GA (US)

Correspondence Address: GARDNER GROFF, P.C., 2018 POWERS FERRY ROAD, SUITE 800, ATLANTA, GA, 30339, US

(21) Appl. No.: 11/009,452

(22) Filed: Dec. 10, 2004

Related U.S. Application Data
(60) Provisional application No. 60/528,309, filed on Dec. 10, 2003.

(51) Int. Cl. E06C 7/42

(52) U.S. Cl. 182/107

(57) ABSTRACT

An apparatus for use against a building, wall or the like structure having an upright surface including a ladder having a pair of parallel side rails with top ends and bottom ends and a plurality of rungs extending therebetween and a stabilizing device secured adjacent the top ends of the rails of the ladder for engaging the upright surface. The stabilizing device has a pivot member pivotally mounted to the rails for pivotal motion relative to the rails and a resilient face for engaging the upright surface and to help resist slipping. The pivot member allows the resilient face to confront the upright surface over a range of angular orientations of the rails relative to the upright surface. Preferably, the resilient face has a non-marring and slip resistant surface for engaging the upright surface.

### CROSS-REFERENCE TO RELATED APPLICATIONS

The present application claims the priority benefit of U.S. provisional patent application Ser. No. 60/528,309, filed Dec. 10, 2003 and incorporates the disclosure of the same herein by reference.

### FIELD OF THE INVENTION

The present invention relates generally to the field of ladders and more particularly to a safety device for a ladder.

### BACKGROUND OF THE INVENTION

Many ladders manufactured today have a plastic piece attached to the top of each rail to rest against a wall (or a side of a house) to protect the wall. However, the plastic pieces offer little grip to keep the ladder from slipping sideways. If the person on the ladder extends himself or herself too far off the center of the ladder, the ladder can slide laterally off the wall, which in turn can cause the person to fall off the ladder and incur a serious injury.

To prevent the ladder from sliding off the wall, some ladders incorporate stabilizing devices attached to the top and/or bottom of the ladder. Most stabilizing devices located at the tops of the ladders have metal bars that extend out from the side rails of the ladder. These metal bars turn downwardly and rest against the wall, while incorporating a flat piece of plastic to protect the wall somewhat. Although these devices help to stabilize the ladder, they also tend to make moving the ladder from point to point around the house more difficult, as well as to make transporting and storing the ladder, on a truck or at home, more difficult.

Others have tried to improvise a stabilizing device by wrapping foam around the upper end of the ladder and then using duct tape to secure the foam to the ladder. Although the foam helps to protect the side of the house, the duct tape offers little resistance to a sideways skid of the ladder if the user reaches too far off the center of the ladder.

Thus, it has been found that a need yet exists for an improved safety device for a ladder, which ladder is safe in use and easy to assemble, transport, and store. It is to the provision of such an improved safety device for a ladder meeting these and other needs that the present invention is primarily directed.

### SUMMARY OF THE INVENTION

Briefly described, in an illustrative form the present invention comprises an apparatus for use against a building, wall or the like structure having an upright surface. The apparatus includes a ladder having a pair of parallel side rails having top ends and bottom ends, a plurality of rungs extending therebetween, and a stabilizing device secured adjacent the top ends of the rails of the ladder for engaging the upright surface. The stabilizing device has a pivot member pivotally mounted to the rails for pivotal motion relative to the rails and a resilient face for engaging the upright surface and to help resist slipping. Preferably, the resilient face is non-marring and slip-resistant. The pivot member also allows the resilient face to confront the upright surface over a range of angular orientations of the rails relative to the upright surface.

Preferably, the stabilizing device is mounted to the rails by a pair of pivot axles, one coupled to each rail. Also preferably, the rails each have a mounting bolster secured thereto and the stabilizing device is mounted to the rails at the mounting bolsters.

In another form, the present invention comprises a safety device for use with an extension ladder of the type having a pair of parallel side rails having top ends and bottom ends. The safety device is provided to minimize slippage between the extension ladder and a building, wall or other structure having an upright surface. The safety device includes a pivot member pivotally secured adjacent the top ends of the rails and having a resilient face plate for engaging the upright surface. Preferably, the pivot member further includes a mounting assembly for mounting the pivot member to the tops of the rails. The mounting assembly further includes a rail bolster for coupling the safety device to the ladder.

Preferably, the resilient face plate has a width of approximately the distance between the two parallel side rails. The resilient face plate itself has a non-marring and slip-resistant surface for gripping the upright surface. The surface for gripping can be smooth or it can have a tread pattern cut therein.

In yet another form, the present invention comprises an improvement for an extension ladder of the type including a pair of parallel side rails and rungs extending therebetween. The extension ladder has a top and a bottom and is of the type for use against an upright surface. The improvement includes a pivotal safety device pivotally mounted adjacent the top of the extension ladder for engaging an upright surface. The pivotal device further includes a gripping element affixed thereto. The gripping element can have a smooth or nubbly surface, or it can have a tread pattern cut into its surface.

These and other features and advantages of the present invention will become more apparent upon reading the following specification in conjunction with the accompanying drawing figures.

### BRIEF DESCRIPTION OF THE DRAWINGS

FIG. 1 is a perspective view of a ladder having a safety device attached to an upper portion thereto in accordance with an illustrative form of the present invention.

FIG. 2 is a detailed view of the ladder of FIG. 1, showing the safety device attached to the ladder.

FIG. 3 is a sectional view of a mounting assembly portion of the ladder of FIG. 1.

### DETAILED DESCRIPTION OF THE INVENTION

The present invention may be understood more readily by reference to the following detailed description of the invention taken in conjunction with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

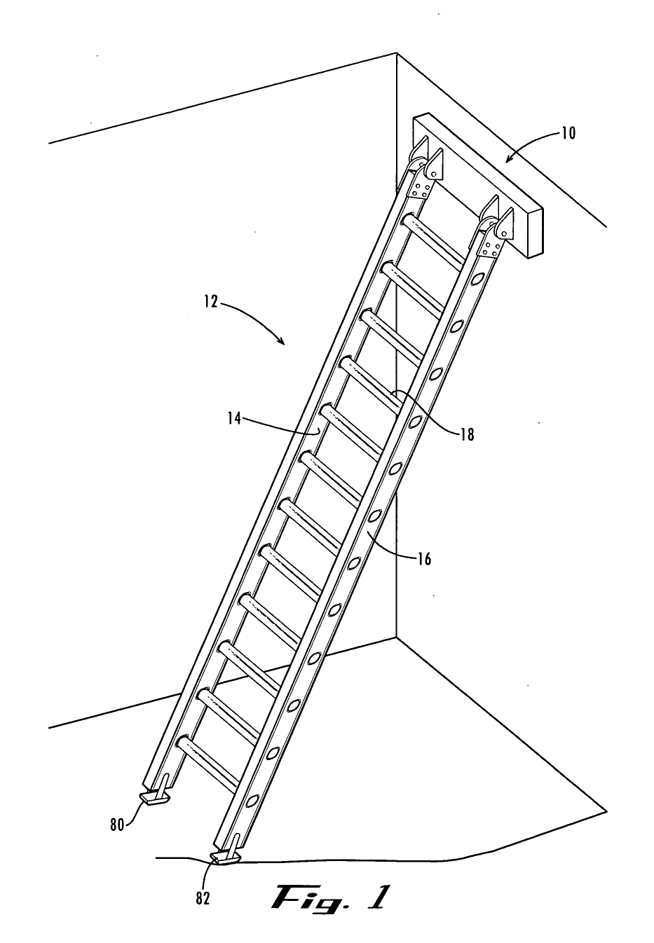

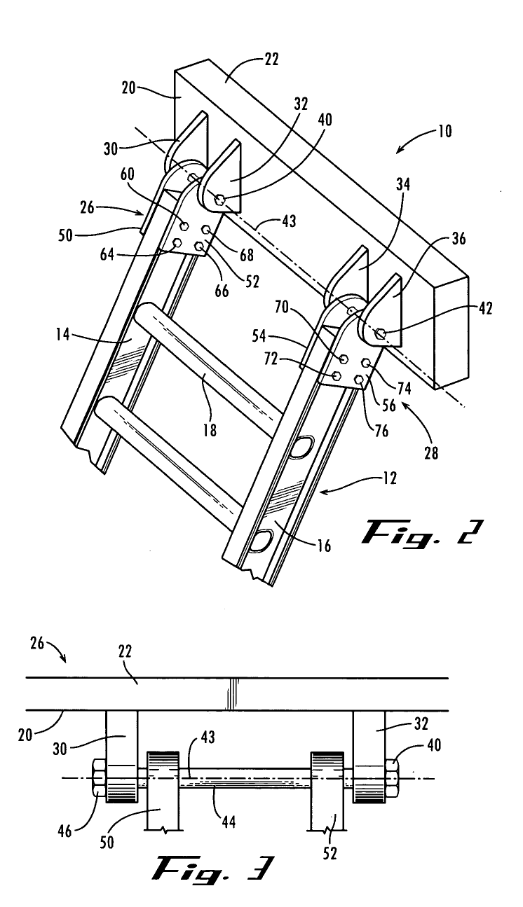

FIGS. 1, 2, and 3 depict a safety or stabilizing device 10 for use with an extension ladder 12, such as a standard aluminum extension ladder. The extension ladder 12 has a pair of parallel side rails 14 and 16, with a plurality of rungs 18 extending therebetween. In standard aluminum ladders, each rail 14 and 16 typically is extruded into a “C”-shaped channel for strength and rigidity. Although the present invention is described herein in terms of use with a conventional aluminum ladder, those skilled in the art will understand that the safety device 10 can be adapted to other extension ladders.

The safety device 10 can be attached to an upper end of the ladder 12 so that the safety device, rather than the ladder itself, contacts and engages a vertical surface such as a wall or a side of the house to better grip and protect the vertical surface. Preferably, the safety device 10 includes a pivot member 20 that can be pivotally attached to the ends of the rails 14 and 16 of the ladder 12. The pivot member 20 can be constructed of metal, wood, or another rigid and resilient material. The front of the pivot member 20 has a face plate or gripping element 22 affixed thereto. Preferably, the gripping element 22 is formed of a resilient, non-marring, and slip-resistant material, such as a soft rubber, although various other resilient, slip resistant, and non-marring materials can be employed as well. Additionally, the gripping element 22 can be smooth, nubbly, or can have a tread pattern cut into its surface to better grip the vertical surface. Also preferably, the width of the safety plate 10 is about the same width as the ladder 12 so that the safety device does not interfere with the transport and storage of the ladder.

The safety device 10 includes a pair of mounting assemblies or clevis arrangements 26 and 28 for mounting the safety device to the rails 14 and 16, respectively, of the ladder 12. The mounting assembly 26 includes a pair of pivot plates or swing arms 30 and 32 and a pivot axle 40, while the mounting assembly 28 includes similar pivot plates or swing arms 34 and 36 and a pivot axle 42. The pivot plates 30, 32, 34, and 36 are secured to the rear of the pivot member 20 and can be permanently affixed thereto. In the depicted embodiment, the pivot plates 30, 32, 34, and 36 are semicircular in shape, although other pivot plates of various shapes and sizes can be employed as well. Preferably, the pivot plates 30, 32, 34, and 36 are constructed of a rigid and resilient material, such as metal, although other materials can be employed as well. Each pivot plate has an opening therethrough for receiving a pivot axle.

Thus, the plates 30 and 32 can pivot about the axle 40, while the plates 34 and 36 can pivot about the axle 42. Preferably, the openings of the pivot plates are all aligned such that the lengths of the pivot axles, when inserted therethrough, define a pivot axis 43. In the exemplary embodiment, the pivot axles 40 and 42 are each a bolt having a smooth shank and a threaded end portion. As seen more clearly in FIG. 3, which shows a cross-sectional view of the mounting assembly 26, the axle 40 has a smooth shank 44 with a threaded end portion (not shown) for receiving a nut 46, which is threaded onto the bolt. Similarly, although not shown in figures, the axle 40 has a smooth shank with a threaded end portion for receiving a nut to hold the bolt in place. In an alternate embodiment, a single pivot axle can be inserted through the openings of the four pivot plates so that the pivot member 20 can pivot about the pivot axis 43.

The mounting assembly 26 also includes a pair of rail or mounting bolsters 50 and 52, while the mounting assembly 28 also includes a pair of rail or mounting bolsters 54 and 56. The rail bolsters 50, 52, 54, and 56 reinforce the connection between the safety device 10 and rails 14 and 16 of the ladder 12. The rail bolsters 50, 52 and 54, 56 are adapted to be mounted to both the inside and outside of the rails 14 and 16, respectively, to couple the safety device 10 to the ladder 12. Alternatively, a single rail bolster can be used for each rail such that the rail bolsters 50 and 54 could be mounted to either the inside or the outside of the rails 14 and 16, respectively, or the rail bolsters could be entirely omitted. In such an embodiment, the pivot axles 40 and 42 could be inserted through holes drilled directly in the rails 14 and 16. Preferably, the rail bolsters 50, 52 and 54, 56 are shaped to match and closely abut the side rails 14 and 16. In the depicted embodiment, the rail bolsters 50, 52 and 54, 56 are flat, but in alternate embodiments, the rail bolsters can follow the contours of the side rails 14 and 16. In the depicted embodiment, the rail bolsters 50, 52 and 54, 56 have a plurality of openings extending therethrough for insertion of fasteners. As shown in the figures, the fasteners are four bolts 60, 62, 64, 66 and 70, 72, 74, 76 that are used for each pair of rail bolsters 50, 52 and 54, 56, respectively. However, those skilled in the art will appreciate that other fasteners, of various shapes, sizes, and number, and fastening methods can be used without departing from the scope of the present invention.

Thus, when the safety device 10 is attached to the ladder 12, the safety device can pivot about the pivot axles 40 and 42 at an angle α relative to the rails 14 and 16 such that the resilient face 22 of the safety device can rest flush against the vertical surface regardless of the angle between the ladder and the ground (or floor). In other words, the pivot member allows 20 the resilient face 22 to confront the upright surface over a range of angular orientations of the rails 14 and 16 relative to the upright surface.

Optionally, the ladder 12 can include a pair of swivel feet 80 and 82 or a pair of extenders at the lower ends of the rails 14 and 16 for added stability.

To attach the safety device 10 to the ladder 12, the user attaches the rail bolsters 50, 52 and 54, 56 of the safety device to the rails 14 and 16. The user can drill holes in the rails 14 and 16 of the ladder 12 such that the drilled holes align with the openings in the rail bolsters 50, 52 and 54, 56. Preferably, any existing plastic pieces attached to the ends of the rails are removed prior to attaching the safety device 10. Also preferably, any paint or other debris that would interfere with the mounting of the rail bolsters 50, 52, 54, and 56 is removed. The rail bolsters 50 and 52 are placed over the rail 14 such that the openings in the rail bolsters align with the drilled holes in the rail. The four fasteners, or bolts, 60, 62, 64 and 66 are inserted through the openings and are secured with a nut. Similarly, the rail bolsters 54 and 56 are placed over the rail 16 such that the openings in the rail bolsters align with the drilled holes in the rail. The four fasteners, or bolts, 70, 72, 74 and 76 are inserted through the openings and are secured with a nut.

While the invention has been described with reference to preferred and exemplary embodiments, it will be understood by those skilled in the art that a variety of modifications, additions and deletions are within the scope of the invention, as defined by the following claims.

1. An apparatus for use against a building, wall or the like structure having an upright surface, the apparatus comprising:
a ladder having a pair of parallel side rails having top ends and bottom ends and a plurality of rungs extending therebetween; and
a stabilizing device secured adjacent the top ends of the rails of the ladder for engaging the upright surface, the stabilizing device comprising a pivot member pivotally mounted to the rails for pivotal motion relative to the rails, the pivot member having a resilient face for engaging the upright surface and to help resist slipping, and the pivot member allowing the resilient face to confront the upright surface over a range of angular orientations of the rails relative to the upright surface.

2. The apparatus of claim 1, wherein the stabilizing device is mounted to the rails by a pair of pivot axles, one coupled to each rail.

3. The apparatus of claim 1, wherein the stabilizing device is mounted to each of the rails with a clevis arrangement.

4. The apparatus of claim 1, wherein the rails each have a mounting bolster secured thereto and the stabilizing device is mounted to the rails at the mounting bolsters.

5. The apparatus of claim 1, wherein the pivot member comprises a rigid plate pivotable about a pivot axis.

6. The device of claim 1, wherein the resilient face is non-marring.

7. The device of claim 1, wherein the resilient face is slip-resistant.

8. The device of claim 1, wherein the resilient face is smooth.

9. The device of claim 1, wherein the resilient face has a tread pattern cut therein.

10. A safety device for use with an extension ladder of the type having a pair of parallel side rails having top ends and bottom ends, the safety device provided to minimize slippage between the extension ladder and a building, wall or other structure having an upright surface, the safety device comprising:
a pivot member pivotally secured adjacent the top ends of the rails and having a resilient face plate for engaging the upright surface.

11. The safety device of claim 10, wherein the pivot member further comprises a mounting assembly for mounting the pivot member to the tops of the rails.

12. The safety device of claim 11, wherein the mounting assembly further comprises a rail bolster for coupling the safety device to the ladder.

13. The safety device of claim 10, wherein the resilient face plate has a width of approximately the distance between the two parallel side rails.

14. The safety device of claim 10, wherein the resilient face plate has a surface for gripping the upright surface.

15. The device of claim 14, wherein the surface for gripping is non-marring.

16. The device of claim 14, wherein the surface for gripping is slip-resistant.

17. The device of claim 14, wherein the surface for gripping is smooth.

18. The device of claim 14, wherein the surface for gripping has a tread pattern cut therein.

19. In an extension ladder of the type including a pair of parallel side rails and rungs extending therebetween, the extension ladder of the type for use against an upright surface and having a top and a bottom, the improvement therein comprising:
a pivotal safety device pivotally mounted adjacent the top of the extension ladder for engaging an upright surface.

20. The improvement of claim 19, wherein the pivotal safety device further comprises a gripping element affixed thereto.

21. The improvement of claim 20, wherein the gripping element has a smooth surface.

22. The improvement of claim 20, wherein the gripping element has a nubbly surface.

23. The improvement of claim 20, wherein the gripping element has a tread pattern cut into its surface.

24. The improvement of claim 19, wherein the pivotal safety device is a rigid structure spanning the distance between the two parallel side rails.
